(19) United States
(12) Patent Application Publication
(10) Pub. No.: US 2013/0088708 A1
(43) Pub. Date: Apr. 11, 2013

(54) APPARATUS FOR OPTICALLY DETECTING FOREIGN OBJECT

(71) Applicant: Shih-Pin WU, Taipei (TW)

(72) Inventor: Shih-Pin WU, Taipei (TW)

(73) Assignee: International Currency Technologies Corp.

(21) Appl. No.: 13/253,967

(22) Filed: Oct. 6, 2011

(51) Int. Cl. G01N 21/00

(52) U.S. Cl. 356/72

(57) ABSTRACT

An apparatus for optically detecting foreign object in a tunnel of a valuable document validator includes a light emitter, a light detector, a beam splitter, a beam combiner, a first reflector and a second reflector. The beam splitter splits a light beam emitted from the light emitter into a first beam and a second beam. The beam combiner combines the first beam and the second beam and transmits the combined light beam to the light detector. The first reflector reflects the second beam. The second reflector receives the second beam reflected by the first reflector and reflects the second beam to the beam combiner.

### BACKGROUND OF THE INVENTION

1. Field of the Invention

The present invention relates to a detecting apparatus, in particularly to an apparatus for optically detecting a foreign object in a tunnel of a valuable document validator.

2. Description of Related Art

Since people require high efficiency and convenience in modern life, many kinds of automatic vending machines, such as ticket seller machine, money exchanger and teller machine are placed at many public locations. However, in some public locations some of the automatic vending machines are not under monitoring. For avoiding fraud, a validator is often installed in the automatic vending machine for identifying valuable documents. Beside that, an anti-stealing device is also installed in the automatic vending machines to prevent thieves from stealing the valuable documents in the automatic vending machines.

One of the stealing approaches is to attach a foreign object such as a wire to a valuable document and then insert the valuable document into the automatic vending machine. After identified by the validator and the credit was recorded by the automatic vending machine, the valuable document can be pulled out from the automatic vending machine by the wire. In order to prevent the stealing, a cutting device is installed in the automatic vending machine for breaking the foreign object attached on the valuable document. When the valuable document is pulled out, the cutting device can break the foreign object attached on the valuable document right away and prevent the valuable document from pulling out.

However, such a cutting device is activated by sensing the force to pull out the valuable document and has poor reliability. Therefore, there is a need to develop an effective and high-resolution detecting apparatus for the foreign object and to prevent such stealing of the valuable document.

### SUMMARY OF THE INVENTION

Accordingly, the objective of the present invention is to provide an apparatus for detecting a foreign object in a tunnel of a valuable document validator.

For achieving the above mentioned objective, the present invention provides an apparatus for optically detecting a foreign object in a tunnel of a valuable document validator. The valuable document validator includes a first side and a second side opposite to the first side. The tunnel is formed between the first side and second side. The apparatus includes a light emitter, a light detector, a beam splitter, a beam combiner, a first light reflector and a second light reflector. The light emitter is located at the first side and emitting a light beam toward the second side. The light detector is located at the second side and faces the light emitter. The beam splitter is located at the first side for splitting the light beam into a first beam and a second beam. The beam combiner is located at the second side for combining the first beam and the second beam. The first light reflector is located at the first side for reflecting the second beam through the tunnel and to the second side. The second light reflector is located at the second side for receiving the second beam from the first reflector and reflecting the second beam to the light combiner.

The present invention also provides an apparatus for optically detecting a foreign object in a tunnel of a valuable document validator. The valuable document validator includes a first side and a second side opposite to the first side. The tunnel is formed between the first side and the second side. The apparatus includes a light emitted located at the first side and emitting a light beam toward the second side. The light detector is located at the second side and faces the light emitter. The light detector is a photodiode or a phototransistor for detecting the signal of the light beam.

The present invention also provides an apparatus for optically detecting a foreign object in a tunnel of a valuable document validator. The valuable document validator includes a first side and a second side opposite to the first side. The tunnel is formed between the first side and the second side. The apparatus includes a light emitter and a light detector. The light emitter is located at the first side and emitting a light beam toward the second side. The light detector is located at the second side and faces the light emitter. The light detector is a charge coupled device or a complementary metal oxide semiconductor image sensor for detecting the propagating direction and the signal of the light beam.

The present invention also provides an apparatus for optically detecting a foreign object in a tunnel of a valuable document validator. The valuable document validator includes a first side and a second side opposite to the first side. The tunnel is formed between the first side and the second side. The apparatus includes a light emitter, a light detector and a phase detector. The light emitter is located at the first side and emitting a light beam toward the second side. The light detector is located at the second side and facing the light emitter. The phase detector is located at the second side and electrically connected with the light detector for detecting the phase of the light beam.

The present invention also provides an apparatus for optically detecting a foreign object in a tunnel of a valuable document validator. The valuable document validator includes a first side and a second side opposite to the first side. The tunnel is formed between the first side and the second side. The apparatus includes a light emitter and a light detector. The light emitter is located at the first side and emitting a light beam toward the second side. The light detector is located at the second side and facing the light emitter. The light detector is a spectrum analyzer for detecting the wavelength of the light beam.

The apparatus of the present invention utilizes the light detectors for detecting the signal, the propagating direction, the phase and the wavelength of the light beam emitted from the light emitter and delivered through the tunnel. In addition, the apparatus also utilizes the beam splitter and the beam combiner for changing the propagating direction, which is a more effective way to find out if there is a foreign object in the tunnel of the valuable document validator.

### BRIEF DESCRIPTION OF THE DRAWINGS

FIG. 1 is a schematic view of a valuable document validator of the present invention;

FIG. 2 is an optical schematic view of an apparatus for optically detecting foreign object according to the first embodiment of the present invention;

FIG. 3A is an optical schematic view of an apparatus for optically detecting foreign object according to the second embodiment of the present invention;

FIG. 3B is an optical schematic view of an apparatus for optically detecting foreign object according to the third embodiment of the present invention;

FIG. 4 is an optical schematic view of an apparatus for optically detecting foreign object according to the first embodiment of the present invention;

FIG. 5 is an optical schematic view of an apparatus for optically detecting foreign object according to the second embodiment of the present invention;

FIG. 6 is an optical schematic view of an apparatus for optically detecting foreign object according to the third embodiment of the present invention; and

FIG. 7 is an optical schematic view of an apparatus for optically detecting foreign object according to the fourth embodiment of the present invention.

### DETAILED DESCRIPTION OF THE INVENTION

A detailed description of the present invention will be made with reference to the accompanying drawings.

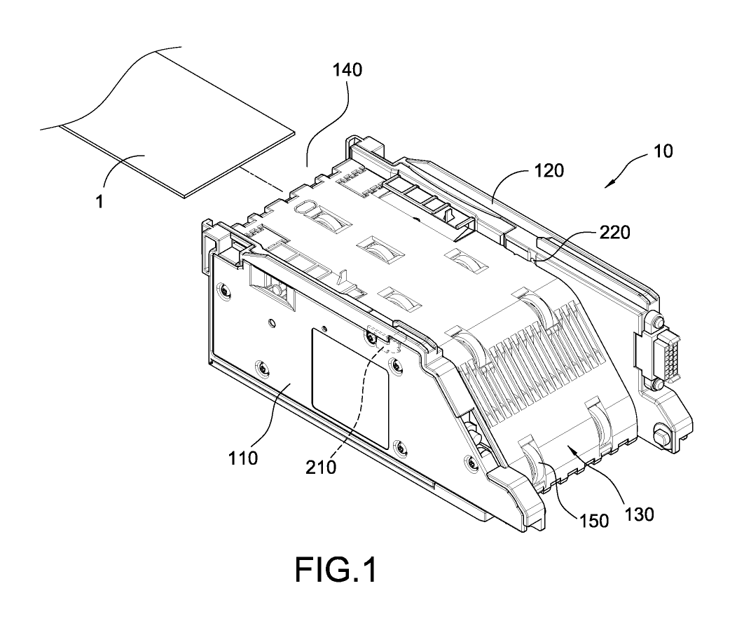

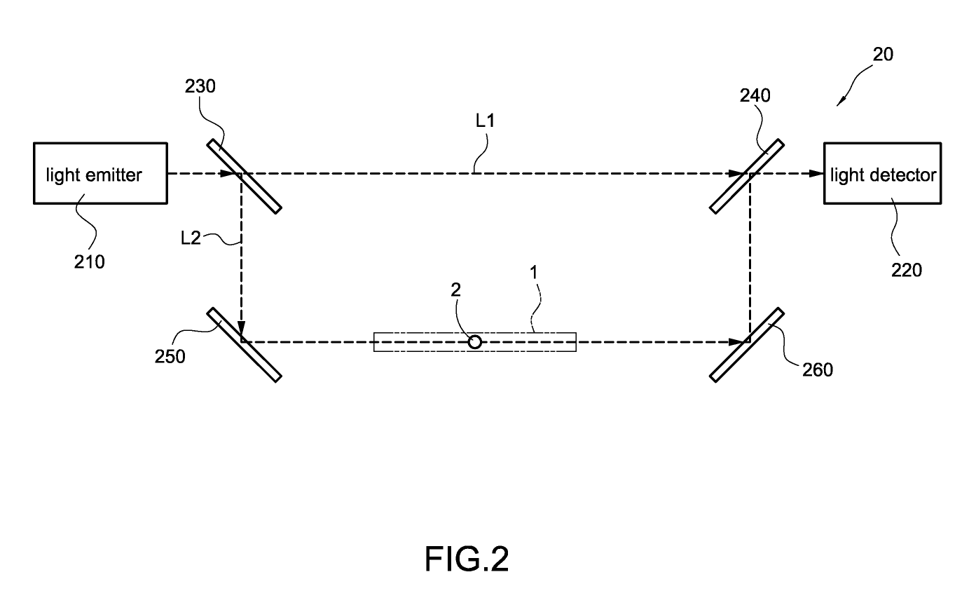

FIG. 1 and FIG. 2 are respectively a schematic view and an optical view of the apparatus for detecting a foreign object in a tunnel of a valuable document validator of the present invention. The valuable document validator is used for installing in an automatic vending machine. In this embodiment, the valuable document validator is, for example, a bill validator.

The valuable document validator includes a base 10 and an apparatus 20 for optically detecting a foreign object. The base 10 includes a first side 110 and a second side 120. A tunnel 130 is formed between the first side 110 and the second side 120 for delivering through a valuable document 1 such as a bill. In this embodiment, the first side 110 and the second side 120 are respectively located at two opposite sides of the tunnel 130. The front end of the tunnel 130 is used as a bill inlet 140. The rear end of the tunnel 130 is communicated to a storage device (not shown) for reserving the valuable document 1. The base 10 also includes a plurality of pulleys 150 used for guiding the valuable document 1 inserted from the bill inlet 140. Thus, the delivery of the valuable document 1 in the tunnel 130 can be more smoothly.

The apparatus 20 is used for detecting a foreign object attached on the valuable document 1. The foreign object includes opaque wire such as silk wire, linen wire or cotton wire, or transparent wire such as fishing wire or Mylar strip. The apparatus 20 includes a light emitter 210, a light detector 220, a beam splitter 230, a beam combiner 240, a first reflector 250 and a second reflector 260.

The light emitter 210 is located at the first side 110 and emits a light beam for detecting foreign object. The light emitter 210 can be light emitting diode (LED), laser diode (LD), light bulb or fluorescent tube. The light detector 220 is located at the second side 120 and faces the light emitter 210 for receiving the light beam.

The light detector 220 can be CCD, CMOS image sensor, photodiode, phototransistor or spectrum analyzer. The CCD, CMOS image sensor, photodiode and phototransistor are used for detecting the foreign object 2 in the tunnel 130 by the signal of the light beam. The spectrum analyzer is used for receiving the light beam and analyzing the spectrum of the light beam. For example, a fluorescent foreign object in the tunnel 130 can be detected by the spectrum analyzer. Therefore, when a foreign object is detected in the tunnel 130 by the light detector 220, a corresponding device can cut to the foreign object or shut down the electrical power or other measures to prevent a thief from pulling out the valuable document 1 in the valuable document validator.

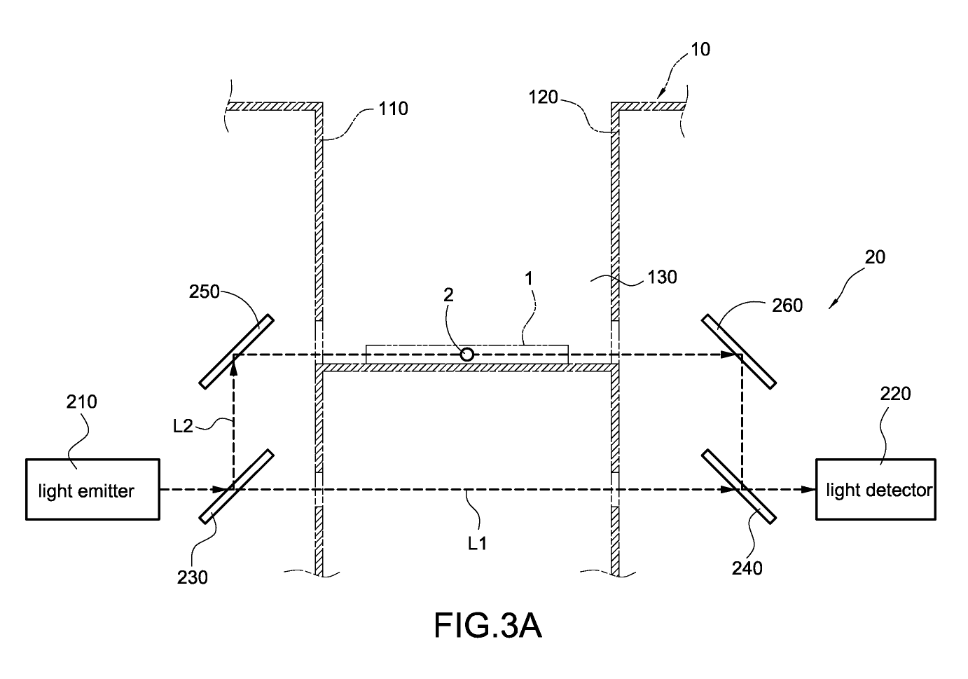

The beam splitter 230 is located at the first side 110 and between the light emitter 210 and the light detector 220. The light beam emitted from the light emitter 210 is split by the beam splitter 230 into a first beam L1 and a second beam L2. One of the first beam L1 and the second beam L2 is directed through the tunnel 130 from the first side 110 to the second side 120. The apparatus 20 needs only one light beam existing in the tunnel 130. As FIG. 3A shows, the light beam existing in the tunnel 130 is the second beam L2. Alternatively, as FIG. 3B shows, the light beam existing in the tunnel 130 is the second beam L1. The description below is made basing on FIG. 3A for illustration. The beam splitter 230 can be a beam splitter plate or a beam splitter cube. In this embodiment, the beam splitter 230 is, for example, a beam splitter plate.

The beam combiner 240 is located at the second side 120 and between the beam splitter 230 and the light detector 220. The beam combiner 240 is used for combining the first beam L1 and the second beam L2 into a combined light beam and transmitting the combined light beam to the light detector 220. The beam combiner 240 can be a beam combiner plate or a beam combiner cube. In this embodiment, the beam combiner 240 is, for example, a beam combiner plate.

The first reflector 250 is located at the first side 110 for reflecting the second beam L2 through the tunnel 130 and toward the second side 120. The first reflector 250 can be a reflective mirror or a prism. In this embodiment, the first reflector 250 is, for example, a reflective mirror.

The second reflector 260 is located at the second side 120 for receiving the second beam L2 from the first reflector 250 and reflecting the second beam L2 toward the beam combiner 240. The second reflector 260 can be a reflective mirror or a prism. In this embodiment, the second reflector 260 is, for example, a reflective mirror.

When a valuable document 1 is inserted into the bill inlet 140, the valuable document 1 was delivered by the pulleys 150 through the tunnel 130. After the valuable document 1 passed through, if there is no foreign object in the tunnel 130, the light detector 220 will detect a steady light signal.

However, in case that a foreign object is attached on the valuable document 1, after the valuable document 1 passed through the tunnel 130, the foreign object will still exist in the tunnel 130. The foreign object will obstruct the second beam L2 and change the light distribution of the second beam L2. Consequently, the light detector 220 will detect the change of the light signal and judge that the existence of the foreign object in the tunnel 130.

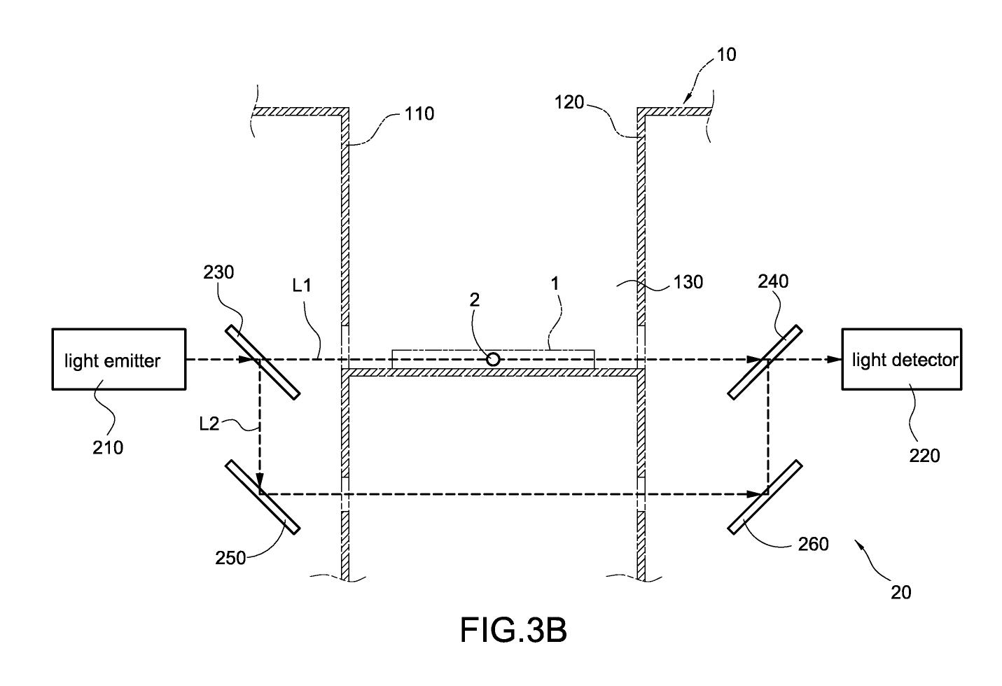

It should be mentioned that the CCD or CMOS image sensor both have a plurality of image pixels each can sense light signal individually. The CCD and CMOS image sensor can measure the shift distance of the first beam L1 or the second beam L2 which is obstructed by the foreign object. Then the foreign object can be found in the tunnel 130. When no shift distance is measured between the first beam L1 and the second beam L2, there is no foreign object in the tunnel 130. When a shift distance of the second beam L2 caused by the foreign object 2 is measured, as shown in FIG. 4, the foreign object 2 is found in the tunnel 130.

Besides, the first beam L1 and the second beam L2 both from the light emitter 210 should have the same first wavelength. When the foreign object in the tunnel 130 has fluorescent substance, the fluorescent substance will convert the wavelength of part of the second beam L2 to a second wavelength. The spectrum analyzer can obtain the corresponding signals of the first wavelength and the second wavelength, and the foreign object 2 is found in the tunnel 130.

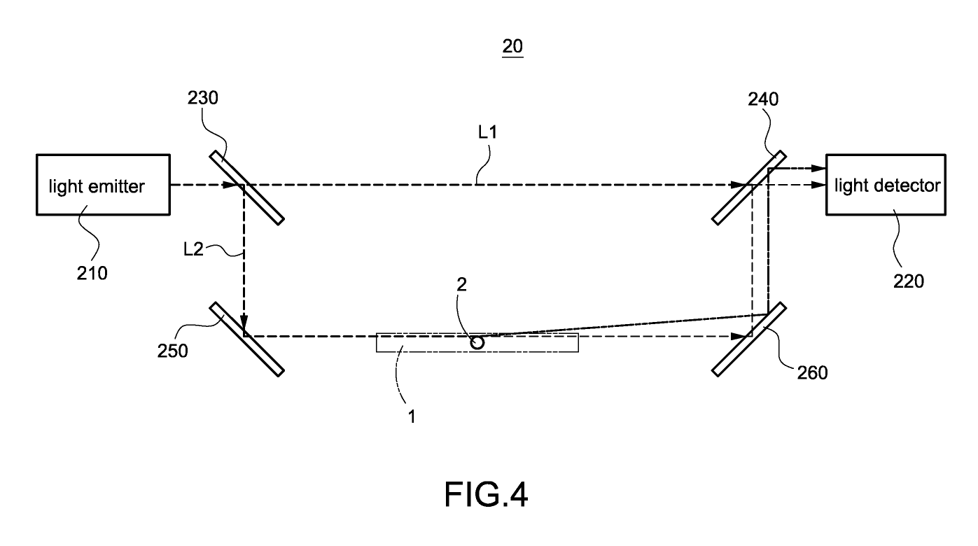

FIG. 5 shows an apparatus for detecting foreign object according to the second embodiment of the present invention. The apparatus 30 is substantially the same as the first embodiment. The difference is that the apparatus 30 further includes a phase detector 370. The phase detector 370 is a phase-locked loop (PLL) or a lock-in amplifier. As FIG. 1 and FIG. 5 show, the phase detector 370 is electrically connected to the light detector 220. The phase detector 370 is used for detecting the phase difference between the first beam L1 and the second beam L2. When a foreign object 2 is present in the tunnel 130, the phase of the second beam L2 will be changed, and the phase change can be detected by the phase detector 370 for determining the existence of the foreign object in the tunnel 130.

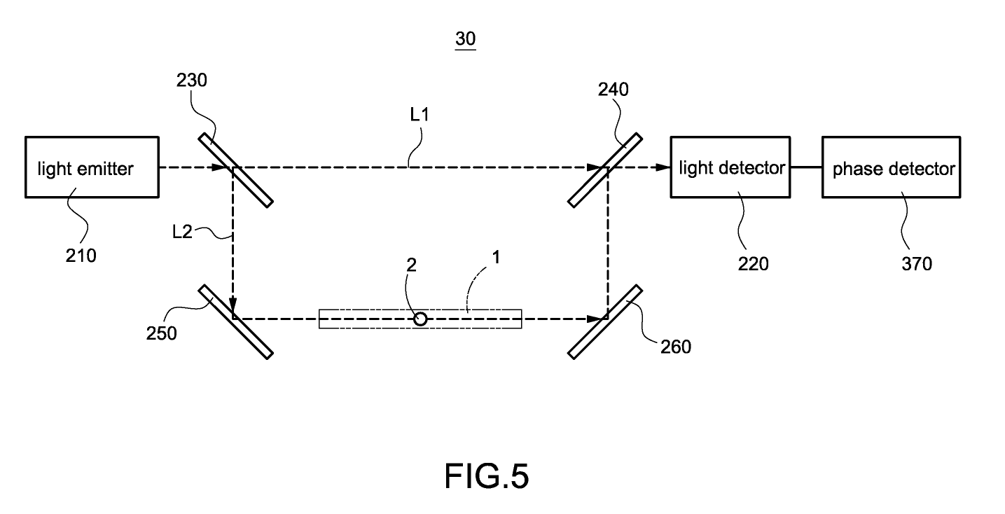

FIG. 6 shows an apparatus for optically detecting foreign object according to the third embodiment of the present invention. The apparatus 40 includes a light emitter 410 and a light detector 420.

As FIG. 1 and FIG. 6 show, the light emitter 410 is located at the first side 110 of the base 10 and emits a light beam toward the second side 120. In this embodiment, the light emitter 410 can be light emitting diode, laser diode, light bulb or fluorescent tube for emitting a light beam.

The light detector 420 is located at the second side 120 and faces the light emitter 410 for detecting the light beam. The light detector 420 can be CCD, CMOS image sensor, photodiode or phototransistor for receiving the light beam and analyzing the signal of the light beam.

It should be mentioned that the CCD and CMOS image sensor can measure the shift distance of the first beam L1 or the second beam L2 which is obstructed by the foreign object. Then the foreign object can be found in the tunnel 130.

Alternatively, the light detector 420 can be spectrum analyzer for detecting the wavelength of the light beam when the foreign object in the tunnel 130 has fluorescent substance. When there is no foreign object with fluorescent substance in the tunnel 130, the spectrum analyzer can obtain the corresponding band of the first wavelength of the first beam L1. When there is a foreign object with fluorescent substance in the tunnel 130, the spectrum analyzer can obtain the corresponding band of the second wavelength converted by the fluorescent substance from part of the first beam L1, and the foreign object 2 is found in the tunnel 130.

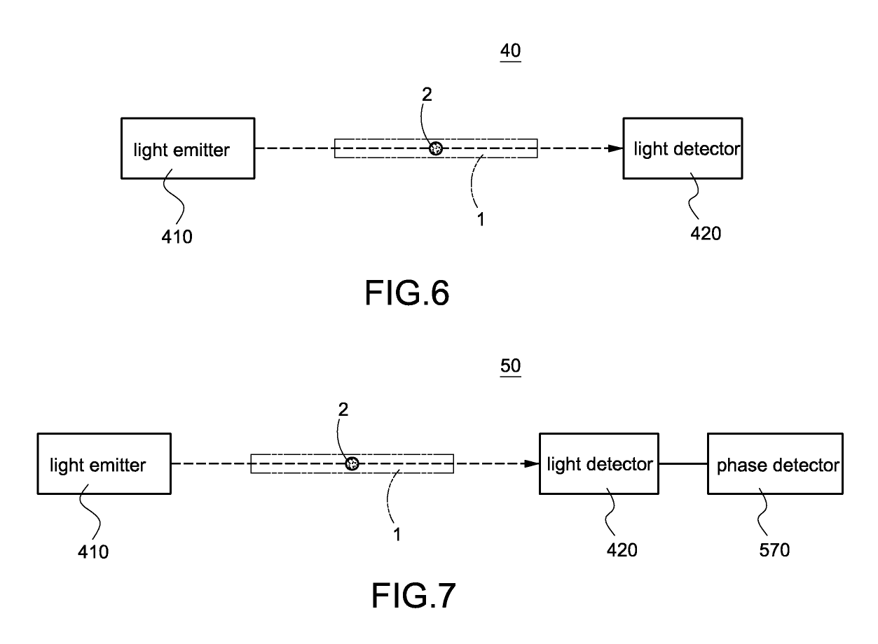

FIG. 7 shows an apparatus for optically detecting foreign object according to the fourth embodiment of the present invention. The apparatus 50 is substantially the same as the third embodiment. The difference is that the apparatus 50 further includes a phase detector 570. The phase detector 570 is a PLL or a lock-in amplifier. As FIG. 1 and FIG. 7 show, the phase detector 570 is electrically connected to the light detector 420. The phase detector 570 is used for detecting the phase changes of the first beam L1 and determining that the existence of the foreign object in the tunnel 130.

In conclusion, the apparatus utilizes the light detectors for detecting the signal, the propagating direction, the phase and the wavelength of the light beam emitted from the light emitter and delivered through the tunnel. In addition, the apparatus utilizes the beam splitter and the beam combiner for changing the propagating direction, which is a more effective way to find out if there is a foreign object in the tunnel.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An apparatus for optically detecting a foreign object in a tunnel of a valuable document validator, the valuable document validator comprising a first side and a second side opposite to the first side, the tunnel being formed between the first side and second side, the apparatus comprising:
a light emitter located at the first side and emitting a light beam toward the second side;
a light detector located at the second side and facing the light emitter;
a beam splitter located at the first side for splitting the light beam into a first beam and a second beam;
a beam combiner located at the second side for combining the first beam and the second beam;
a first light reflector located at the first side for reflecting the second beam through the tunnel and to the second side; and
a second light reflector located at the second side for receiving the second beam from the first reflector and reflecting the second beam to the light combiner.

2. The apparatus as claim 1, wherein the light detector is a photodiode, a phototransistor for detecting the signal of the light beam.

3. The apparatus as claim 1, wherein the light detector is a charge coupled device, a complementary metal-oxide-semiconductor image sensor for detecting the propagating direction and the signal of the light beam.

4. The apparatus as claim 1, further comprising a phase detector located at the second side and electrically connected to the light detector for detecting the phase difference between the first beam and the second beam.

5. The apparatus as claim 1, wherein the light detector is a spectrum analyzer for detecting the wavelengths of the first beam and the second beam.

6. The apparatus as claim 1, wherein the light emitter is a light emitting diode, a laser diode, a light bulb or a fluorescent tube.

7. The apparatus as claim 1, wherein the beam splitter and beam combiner are beam combiner plates or beam combiner cubes.

8. The apparatus as claim 1, wherein the first reflector and the second reflector are reflective mirrors or prisms.

9. An apparatus for optically detecting a foreign object in a tunnel of a valuable document validator, the valuable document validator comprising a first side and a second side opposite to the first side, the tunnel being formed between the first side and the second side, the apparatus comprising:
a light emitted located at the first side and emitting a light beam toward the second side; and
a light detector located at the second side and facing the light emitter,
wherein the light detector is a photodiode or a phototransistor for detecting the signal of the light beam.

10. An apparatus for optically detecting a foreign object in a tunnel of a valuable document validator, the valuable document validator comprising a first side and a second side opposite to the first side, the tunnel being formed between the first side and the second side, the apparatus comprising:
a light emitter located at the first side and emitting a light beam toward the second side; and
a light detector located at the second side and facing the light emitter,
wherein the light detector is a charge coupled device or a complementary metal oxide semiconductor image sensor for detecting the propagating direction and the signal of the light beam.

11. An apparatus for optically detecting a foreign object in a tunnel of a valuable document validator, the valuable document validator comprising a first side and a second side opposite to the first side, the tunnel being formed between the first side and the second side, the apparatus comprising:
a light emitter located at the first side and emitting a light beam toward the second side;
a light detector located at the second side and facing the light emitter; and
a phase detector located at the second side and electrically connected with the light detector for detecting the phase of the light beam.

12. An apparatus for optically detecting a foreign object in a tunnel of a valuable document validator, the valuable document validator comprising a first side and a second side opposite to the first side, the tunnel being formed between the first side and the second side, the apparatus comprising:
a light emitter located at the first side and emitting a light beam toward the second side; and
a light detector located at the second side and facing the light emitter,
wherein the light detector is a spectrum analyzer for detecting the wavelength of the light beam.
